(19) United States
(12) Patent Application Publication
(10) Pub. No.: US 2010/0320135 A1
(43) Pub. Date: Dec. 23, 2010

(54) WATER PURIFICATION KETTLE

(76) Inventor: WEN-CHON SUN, Taipei (TW)

Correspondence Address: LEONG C. LEI, PMB # 1008, 1839 YGNACIO VALLEY ROAD, WALNUT CREEK, CA, 94598, US

(21) Appl. No.: 12/487,671

(22) Filed: Jun. 19, 2009

(51) Int. Cl. C02F 1/28

(52) U.S. Cl. 210/244

(57) ABSTRACT

A water purification kettle includes a kettle body forming a top open container. A top cover is coupled to the opening of the body and forms a stepped water replenishment hole, a water dispense hole, and a vent hole. A filter is fit into the body through the stepped water replenishment hole and retained in position by the water replenishment hole lid. The filter contains therein in sequence a layer of energy ceramic spheres, a layer of coconut shell activated carbon, a layer of calcium sulfite, and a filtering net. A water dispense knob is coupled to the water dispense hole and forms a water passage and a vent hole. By rotating the water dispense knob to have the water passage corresponding to the water dispense hole and the vent hole aligning each other, water is allowed to pour out from the kettle body.

### TECHNICAL FIELD OF THE INVENTION

The present invention generally relates to a water purification kettle that is easy to operate and convenient for replacement of filter.

### DESCRIPTION OF THE PRIOR ART

Water pollution has been widely observed, and the most serious pollutants include turbidity, microorganisms (such as colibacillas and counts of bacterial colony), and heavy metals. To purify water, chloride is added to disinfection. However, it is not possible to completely remove the pollutants and water may contain excessive chloride, which may leads to terrible odor and may also damage human body. Thus, water filtering devices, such as reverse osmosis (RO) filters, water purifiers, water cleaners or water filters, are commonly used for providing clean and safe water.

To facilitate the use, various simplified water filtering kettles are available in the market. An example is shown in Taiwan Patent Publication M303052 of Dec. 21, 2006. In addition, Taiwan Patent Application No. 095202122 disclosing an RO water purification kettle comprising a sealed high-pressure water filter connected to a pressurization pump. The filter and an RO membrane are attached to a water outlet pipe by circular plastic rings. Raw water is added into the sealed high-pressure filter and a sealing cover is attached through silicone seal rig and clamps to the sealed high-pressure filter. The pressurization pump is manually operated to pump high pressure air into the filter, by which the raw water is forced to flow through the filter and the RO membrane, whereby purified water flows from the water outlet pipe into a water receiving kettle. The water outlet pipe of the sealed high-pressure filter is erected and stands higher than the raw water surface. When the water filtration is stopped and the sealing cover is removed, the purified water inside the filter and the RO membrane flows to the bottom of the filter to re-flush the dirt on the filter and the RO membrane back to the bottom of the filter. The filter may then be removed for releasing the dirty water and the reversed cleaning of the filter can be effected.

### SUMMARY OF THE INVENTION

The known RO water purification kettle, although being easy to carry and convenient for use, requires hand operation of the pressurization pump to apply air pressure to force the raw water inside the filter to flow through the filter and the RO membrane. The pumping operation may bring in suspending microorganisms of the atmosphere into the kettle. Further, the pump may hide dirt and pollutants therein and is not easy to wash, thereby making itself an additional source of contamination. Further, to replace or clean the filter, the cover must be opened in order to remove the filter and after the filter is cleaned or replaced, the cove must be re-secured on the kettle. This is a time-consuming operation.

Thus the present invention aims to overcome the problems of poor operation of the conventional water purification kettle that leads to re-contamination of the purified water and making the filtered water polluted again.

An objective of the present invention is to provide a water purification kettle, which does not need to completely open a top cover for replacing a filter so that time is saved and operation is easy for the general consumers to use the kettle.

Another objective of the present invention is to provide a water purification kettle, which uses a water dispense knob to control opening/closing for water dispensing so as to effectively isolate pollutants in the atmosphere and provide the general consumers with safe and clean drinking water.

To achieve the above objectives, the present invention provides a water purification kettle comprising a kettle body forming a container having an opening facing upward for receiving water therein. The kettle body has a side wall forming a handle. The kettle body has an outside surface forming a label section for attaching a label indicating data regarding replacement of a filter, such as the date when the replacement of the filter is made. A top cover forms on a bottom thereof that is mounted to a top of the kettle body a skirt fit to the opening of he kettle body and carrying a sealing ring for forming tight engagement between the top cover and the kettle body. The top cover has a top forming a water replenishment hole, a water dispense hole, and a vent hole. An upward-extending rim is formed to be larger than the water replenishment hole for coupling with a water replenishment hole lid. The rim and the water replenishment hole form therebetween a circumferential step for supporting a filter. The top cover forms a circumferential mounting flange that comprises a water sealing ring at an opposite side portion for coupling with a water dispense knob and forming the water dispense hole therein in an eccentric manner. The water dispense knob functioning for controlling water dispensing has a bottom surface forming a circumferential groove for mounting to the mounting flange of a rotation section. The water dispense knob has a handle portion extending outward and forming therein a water passage that is positioned on a water dispense hole surface. The water dispense hole is formed inside the circumferential mounting flange, whereby with the water passage of the water dispense knob being in communication with the water dispense hole, opening and closing for water dispensing is realized. Further, the water dispense knob has an opposite handle portion forming therein a vent hole, whereby when the water dispense knob is rotated to a water dispensing position, the vent hole is set in communication with the vent hole of the top cover to vent air for smooth dispensing of water from the kettle body. On the other hand, when the water dispense knob is rotated to a water closing position, the vent hole of the handle portion is shifted away from the vent hole of the top cover and thus blocked, preventing air flowing through the interior space of the kettle body, so as to prevent the water from dispensing from the kettle body. Further, the filter has a top end coupling flange that is hollow and receives a filtering net for filtering out impurities. The bottom of the coupling flange is connected to a filtering section and a water release end defining water discharge slots and the filter contains therein in sequence a layer of calcium sulfite, a layer of coconut shell activated carbon, and a layer of energy ceramic spheres for filtering and purifying water to released filtered water into the kettle body. The water dispense knob that functions for controlling water dispensing is coupled to the mounting flange of the rotation section of the top cover and the water dispense hole is formed inside the mounting flange whereby through communication of the water passage of the water dispense knob with the water dispense hole or not, opening and closing of water dispensing is realized.

With the water purification kettle so constructed, when the water dispense knob is rotated to have the water passage communicating the water dispense hole of the top cover, water is allowed to dispense, and when the water passage of the water dispense knob and the water dispense hole of the top cover are shifted away from each other, the water dispense hole of the top cover is blocked. In this way, a purification kettle that features easy replacement of filter and easy operation is provided.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of the present invention in an assembled form.

FIG. 3 is a cross-sectional view of the present invention.

FIG. 4 shows schematic views demonstrating switching operation between water dispensing and water closing in accordance with the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

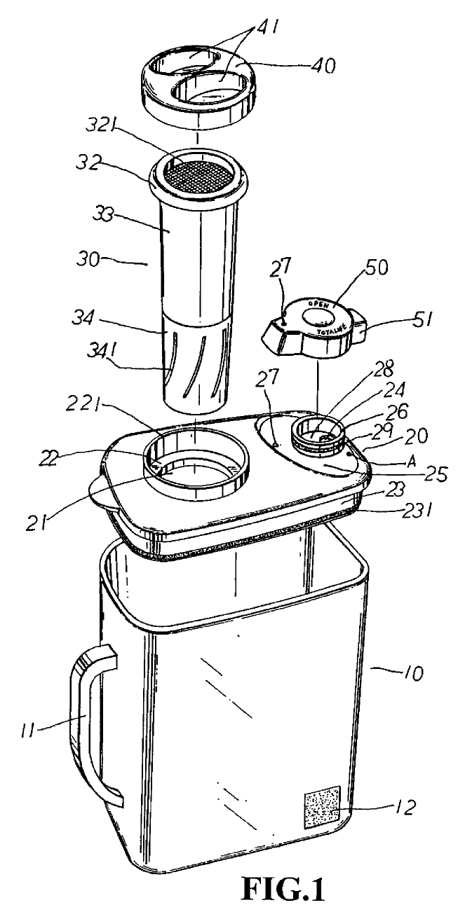

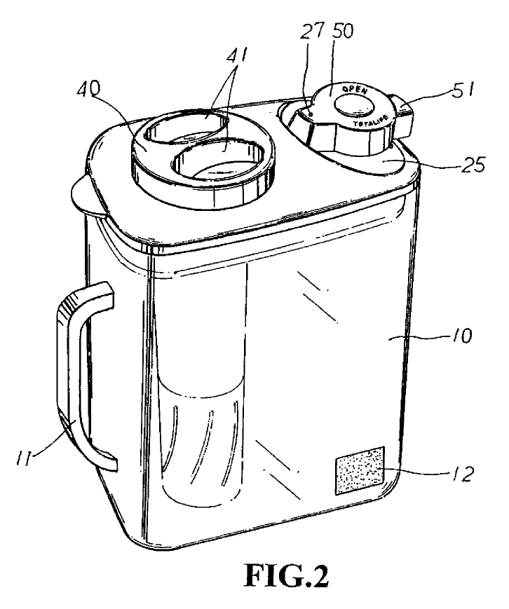

As shown in FIGS. 1 and 2, the present invention comprises a kettle body forming a container having an opening facing upward for receiving water therein. The kettle body 10 has a side wall forming a handle 11. The kettle body 10 has an outside surface forming a label section 12 for attaching a label indicating data regarding replacement of a filter, such as the date when the replacement of the filter is made.

A top cover 20 forms on a bottom thereof that is mounted to a top of the kettle body 10 a skirt 23 fit to the opening of the kettle body 10 and carrying a sealing ring 231 for forming tight engagement when the top cover 20 and the kettle body 10 are coupled together. The top cover 20 has a top forming a water replenishment hole 21, a water dispense hole 24, and a vent hole 27. An upward-extending rim 221 is formed to be larger than the water replenishment hole 21 for coupling with a water replenishment hole lid 40. The rim 221 and the water replenishment hole 21 form therebetween a circumferential step 22 for supporting a filter 30. The top cover 20 forms a circumferential mounting flange 26 that comprises a water sealing ring 29 at an opposite side portion for coupling with a water dispense knob 50 and forming the water dispense hole 24 therein in an eccentric manner.

The filter 30 has a filtering section 33 having a top end forming a circumferential coupling flange 32 positionable on the step 22 of the water replenishment hole 21. The filter 30 contains therein in sequence a layer of calcium sulfite 331, a layer of coconut shell activated carbon 332, and a layer of energy ceramic spheres 333 for filtering and purifying water and has a lower section forming a water release end 34 defining water discharge slots 341 for releasing filtered water into the kettle body 10.

The water dispense knob 50 functioning for controlling water dispensing has a bottom surface forming a circumferential groove 52 for mounting to the mounting flange 26 of a rotation section 25. The water dispense knob 50 has a handle portion 51 extending outward and forming therein a water passage 53 that is positioned on a water dispense hole surface 28. The water dispense hole 24 is formed inside the circumferential mounting flange 26, whereby when the water dispense knob 50 is rotated to such a position where the water passage 53 and the water dispense hole 24 are in communication with each other, the kettle body 10 can be inclined to pour out water. On the other hand, when the water dispense knob 50 is rotated to a position to shift the water passage 53 and the water dispense hole 24 away from each other, water discharge is closed. The water dispense knob 50 has an opposite handle portion 51 forming therein a vent hole 27, whereby when the water dispense knob 50 is rotated to the water dispensing position, the vent hole 27 is set in communication with the vent hole 27 of the top cover 20 to vent air for smooth dispensing of water from the kettle body 10. On the other hand, when the water dispense knob 50 is rotated to the water closing position, the vent hole 27 of the handle portion 51 is shifted away from the vent hole 27 of the top cover 20 and thus blocked, preventing air flowing through the interior space of the kettle body 10, so as to prevent the water from flowing smoothly through the water passage 53 of the water dispense knob 50 for dispensing.

The water replenishment hole lid 40 is coupled to the rim 221 of the top cover 20 and has a top forming two gripping sections 41 for user's operation of opening and closing the water replenishment hole 21.

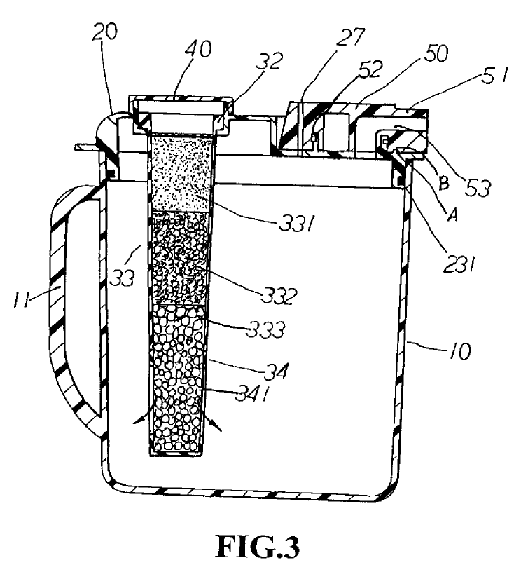

As shown in FIG. 3, which shows a cross-sectional view of the present invention, the top cover 20 is coupled to the kettle body 10 and the water replenishment hole lid 40 is coupled to the rim 221. The coupling flange 32 formed on the top of the filtering section 33 of the filter 30 is positioned on the step 22 of the water replenishment hole 21. The water dispense knob 50 is coupled to the mounting flange 26. When the water passage 53 formed in the outward-extending handle portion 51 is set in communication with the water dispense hole 24, the kettle body 10 can be inclined for pouring water out. The opposite handle portion 51 of the water dispense knob 50 forms the vent hole 27 and when the water dispense knob 50 is rotated to the water dispensing position, the vent hole 27 is set in communication with the vent hole 27 of the top cover 20 to allow air flowing through the kettle body 10 to facilitate smooth discharging of water.

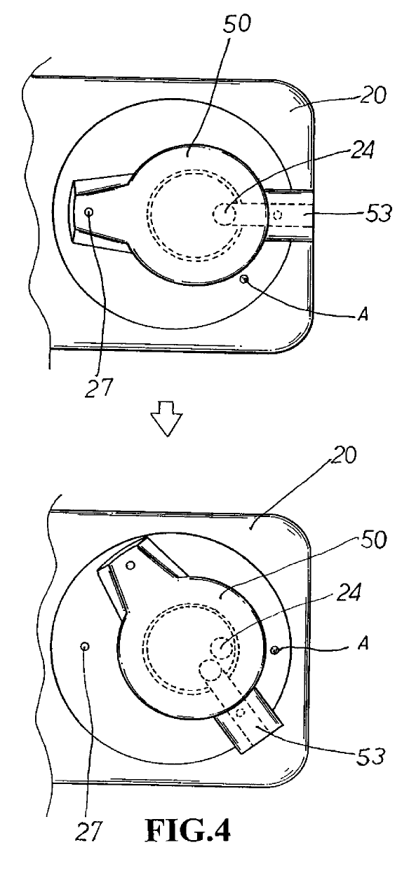

As shown in FIG. 4, which shows schematic views demonstrating switching operation between water dispensing and water closing, the water dispense knob 50 and the rotation section 25 form therebetween opening and closing position-setting bosses A and a position setting dimple B. When the water dispense knob 50 is rotated to such a position where the opening position setting boss A engages the position setting dimple B, the vent hole 27 of the water dispense knob 50 and the vent hole 27 of the top cover are in communication with each other and the water passage 53 of the water dispense knob 50 and the water dispense hole 24 are in communication with each other to define a water dispensing condition (as shown in the upper portion of FIG. 4). When the water dispense knob 50 is rotated to such a position where the closing position setting boss A engages the position setting dimple B, the vent hole 27 of the water dispense knob 50 and the vent hole 27 of the top cover are shifted away from each other and the water passage 53 of the water dispense knob 50 and the water dispense hole 24 of the top cover 20 are shifted away from each other to define a water closing condition (as shown in the lower portion of FIG. 4)

With the water dispense knob 50 being switched to allow the water passage 53 to communicate with the water dispense hole 24 or not, water dispensing and closing are realized. With the water purification kettle as constructed above, by rotating the water dispense knob 50 to communicate with the water dispense hole 24 of the top cover 20, water is allowed to dispense and by rotating the water dispense knob 50 to have the water passage 53 shifted away from the water dispense hole 24 of the top cover 20, the water dispense hole 24 of the top cover 20 is closed. To replenish water, the water replenishment hole lid 40 is opened and a filtering net 321 set at the top end of the filter 30 first filters out impurities and then layer of calcium sulfite 331, the layer of coconut shell activated carbon 332, and the layer of energy ceramic spheres 333 contained inside the filter 30 carried out water filtering and purification and afterwards, the filtered water is released into the interior space of the kettle body 10 through the water discharge slots 341 of the water release end 34. To replace the filter 30, the water replenishment hole lid 40 is opened and the filter 30 is removed and the a new filter 30 is set in again.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A water purification kettle, comprising:
a kettle body, which forms a container having an opening facing upward and has a side wall forming a handle;
a top cover, which is received in the opening of the kettle body and has a bottom forming a skirt fit to the inside wall of the kettle body, the skirt comprising a sealing ring, the top cover forming a stepped water replenishment hole and a water dispense hole both in communication with an interior space of the kettle body, the stepped water replenishment hole forming a rim extending upward for coupling with a water replenishment hole lid, the water dispense hole being surrounded circumferentially by a mounting flange that comprises a water seal ring;
a filter, which is fit into the kettle body through the stepped water replenishment hole and has a top end forming a circumferential coupling flange positionable on a step of the stepped water replenishment hole of the top cover and retained in position by the water replenishment hole lid, the filter having a lower section forming a water release end defining a plurality of water discharge slots in communication with the interior space of the kettle body;
a water dispense knob, which has a bottom surface forming a circumferential groove for mounting to the mounting flange of the top cover, the water dispense knob forming in the bottom thereof a water passage extending to a side surface thereof, whereby water dispensing is controlled by rotating the water dispense knob.

2. The water purification kettle according to claim 1, wherein the filter contains therein in sequence a layer of energy ceramic spheres, a layer of coconut shell activated carbon, a layer of calcium sulfite, and a filtering net.

3. The water purification kettle according to claim 1, wherein the top cover forms a rotation section at a location where the top cover is coupled with water passage of the water dispense knob and a vent hole, the water dispense knob and the rotation section forming therebetween opening and closing position-setting bosses and position setting dimple.

4. The water purification kettle according to claim 2, wherein the top cover forms a rotation section at a location where the top cover is coupled with water passage of the water dispense knob and a vent hole, the water dispense knob and the rotation section forming therebetween opening and closing position-setting bosses and position setting dimple.

5. The water purification kettle according to claim 1, wherein the top cover and the water dispense knob form therebetween corresponding vent holes in communication with the interior space of the kettle body.

6. The water purification kettle according to claim 2, wherein she top cover and the water dispense knob form therebetween corresponding vent holes in communication with the interior space of the kettle body.

7. The water purification kettle according to claim 3, wherein he top cover and the water dispense knob form therebetween corresponding vent holes in communication with the interior space of the kettle body.

8. The water purification kettle according to claim 4, wherein he top cover and the water dispense knob form therebetween corresponding vent holes in communication with the interior space of the kettle body.

9. The water purification kettle according to claim 1, wherein the kettle body has an outside surface forming a label section for attaching a label indicating data regarding replacement of the filter.
